(19) United States
(12) Patent Application Publication
(10) Pub. No.: US 2025/0346077 A1
(43) Pub. Date: Nov. 13, 2025

(54) COUPLING UNIT FOR VEHICLES

(71) Applicant: Zoltán Polyák, Kecskemét (HU)

(72) Inventor: Zoltán Polyák, Kecskemét (HU)

(73) Assignee: ACPS Automotive GmbH, Ingersheim (DE)

(21) Appl. No.: 19/275,208

(22) Filed: Jul. 21, 2025

Related U.S. Application Data
(63) Continuation of application No. PCT/EP2023/051793, filed on Jan. 25, 2023.

(51) Int. Cl. B60D 1/06; B60D 1/48; B60D 1/54

(52) U.S. Cl. CPC B60D 1/06; B60D 1/485; B60D 1/54

(57) ABSTRACT

The invention refers to a coupling unit for vehicles comprising a cross member mounted on a rear region of a vehicle body, a connecting element fixed to said cross member and being adapted to carry a coupling element for coupling a trailer or load carrier to said vehicle for achieving improved stability said connecting element comprises a mounting element provided with a slot for receiving a central section of said cross member, and that said slot forms a contour for being positively bonded to said central section of the cross member on opposite longitudinal side faces of the central section.

### CROSS-REFERENCE TO RELATED PATENT APPLICATION

This application is a continuation of international application number PCT/EP2023/051793 filed on 25 Jan. 2023.

The present disclosure relates to the subject matter disclosed in international application number PCT/EP2023/051793 of 25 Jan. 2023, which is incorporated herein by reference in its entirety and for all purposes.

### BACKGROUND OF THE INVENTION

The invention refers to a coupling unit for vehicles, comprising a cross member mounted on a rear region of a vehicle body, a connecting element, fixed to said cross member and being adapted to carry a coupling element for coupling a trailer or load carrier to said vehicle.

Such coupling units are known from prior art.

In accordance with an embodiment of the invention, a coupling unit with an improved design is provided, enabling a simple deformation as well as vibration insensitive connection of the connecting element to the cross member.

### SUMMARY OF THE INVENTION

In accordance with an embodiment of the invention, provision is made that said connecting element comprises a mounting element provided with a slot for receiving a central section of said cross member and that said slot forms a contour for being positively bonded to said central section of the cross member on opposite longitudinal side faces of the central section.

Due to the fact that the mounting element is provided with a slot receiving the central section of said cross member and being designed such that it can be positively bonded to said central section of the cross member on opposite side faces thereof the connecting element can be easily fixed to said cross member by a positive bonding between said central section of the cross member and said mounting element.

In general said mounting element can have different designs as long as they allow formation of a slot receiving said central section of said cross member.

One advantageous design provides that said mounting element comprises two longitudinal portions forming said slot by being arranged on opposite sides of said slot.

In particular it is of advantage if said slot extends along said central section of said cross member.

In order to improve the bonding between the two longitudinal portions of said mounting element it is of advantage, if said two longitudinal portions extend along said central section of said cross member over a distance corresponding to at least two times, preferably at least three times, the width of said slot.

According to one embodiment of the present invention said mounting element could comprise only two longitudinal portions positively bonded to said central section on opposite longitudinal side faces.

In order to provide a stable connection between said two longitudinal portions an advantageous design provides that said mounting element is provided with connecting flanges connecting said two longitudinal portions of said mounting element.

In particular it is provided that said connecting flanges are arranged at the respective ends of said longitudinal portions for connecting these ends of said longitudinal portions.

A further advantageous solution provides that said connecting flanges are connected to said central section of said cross member by a positive bonding connection.

Preferably said connecting flanges with one of their side edges are facing the central section of the cross member with a contour, in particular a recess, which is positively bonded to said central section.

A particular advantageous solution provides that said slot and the contours of said connecting flanges facing said central section of said cross member form a continuous closed contour which is positively bonded to said cross member, in order to improve the bonding between said mounting element and said central section.

According to the designs explained before there is no specific definition of the orientation of the connecting flanges with respect to said longitudinal portions of said mounting element.

A design which with respect to its stability is preferred provides that said connecting flanges extend in transverse direction to said longitudinal portions of said mounting element.

In particular it is provided that said connecting flanges extend parallel to planes which run transverse to the planes in which said longitudinal portions extend.

A design which is highly advantageous with respect to its stability provides that said longitudinal portions and said connecting flanges are formed from one piece.

According to the designs explained before there is no specific design of the positive bonding defined.

One solution could provide that the positive bonding is achieved by a sequence of bonding points or bonding sections.

A preferred design provides that the positive bonding is achieved by at least one longitudinal bonding seam.

In particular such a longitudinal bonding seam can extend on opposite side faces of said central section of said cross member arranged in said slot.

Preferably said positive bonding is achieved by at least one continuous bonding seam extending along the longitudinal portions and the respective side faces of said central section of said cross member for positively connecting said longitudinal portions to said side faces.

For example each of the longitudinal portions is connected to one side face of the central section by one continuous bonding seam.

An even more improved version of the positive bonding between said mounting element and said central section provides that said positive bonding is achieved by a continuous closed bonding seam connecting said longitudinal portions and said connecting flanges to said central section of said cross member.

Such a continuous closed positive bonding seam therefore extends along the longitudinal portions of said mounting element and also along sections of said connecting flanges abutting on said central section, which are for example formed by the contours on the side edges, in particular the recesses formed thereon.

Said positive bonding seams can be applied on various sides of said mounting element.

One advantageous solution provides that said positive bonding is achieved by a positive bonding seam arranged on said mounting element on a side opposite to said connecting flanges.

Another advantageous solution provides that said positive bonding is achieved by a positive bonding seam arranged on a side of said mounting element on which said connecting flanges are extending.

One particular advantageous solution provides that said bonding seam is arranged on a side of said mounting element opposite to a mounting flange which is connected to said mounting element and adapted for fixing said coupling element.

A further advantageous solution provides that said positive bonding is achieved by a positive bonding seam arranged on a side of said mounting element directed towards a mounting flange which is connected so said mounting element and adapted for fixing said coupling element.

A particular advantageous solution provides that said mounting element on its side directed towards a road surface is carrying a mounting flange extending transverse to the central section of said cross member and transverse to the longitudinal portions of the mounting element.

According to this design the mounting flange is adapted to receive a bearing unit to which the coupling element is connected.

In particular said bearing unit is designed to enable swiveling of the coupling element between a working position in which the coupling element extends transverse to said cross member and a rest position in which the coupling element extends transverse to a longitudinal vertical center plane of the vehicle and/or the coupling unit and/or essentially parallel to said cross member.

In order to stabilize the mounting flange with respect to said mounting element and advantageous solution provides that said mounting flange is stabilized with respect to said mounting element at least one stabilizer which is fixed to said mounting element and to said mounting flange.

In particular a design with a high stability provides that said mounting flange extends between two stabilizers and is fixed to each of the stabilizers.

In particular, advantageous embodiments of the invention comprise the combination of features as defined by the following consecutively numbered embodiments.
1. Coupling unit for vehicles (10) comprising a cross member (22) mounted on a rear region (14) of a vehicle body (12), a connecting element (32) fixed to said cross member (22) and being adapted to carry a coupling element (40) for coupling a trailer or load carrier to said vehicle (10), wherein that said connecting element (32) comprises a mounting element (62) provided with a slot (80) for receiving a central section (64) of said cross member (22), and that said slot (80) forms a contour for being positively bonded to said central section (64) of the cross member (22) on opposite longitudinal side faces (76, 78) of the central section (64).
2. Coupling unit according to embodiment 1, wherein said mounting element (62) comprises two longitudinal portions (66, 68) forming said slot (80) by being arranged on opposite sides thereof.
3. Coupling unit according to embodiment 1 or 2, wherein said slot (80) extends along said central section (64) of said cross member (22).
4. Coupling unit according to embodiments 2 or 3, wherein said two longitudinal portions (66, 68) extend along said central section (64) of said cross member (22) over a distance corresponding to at least two times, preferably at least three times, the width of said slot (80).
5. Coupling unit according to one of the preceding embodiments, wherein said mounting element (62) is provided with connecting flanges (82, 84) connecting said two longitudinal portions (66, 68) of said mounting element (62).
6. Coupling unit according to embodiment 5, wherein said connecting flanges (82, 84) are arranged at the respective ends of said longitudinal portions (66, 68).
7. Coupling unit according to embodiments 5 or 6, wherein said connecting flanges (82, 84) are connected to said central section (64) of said cross member (22) by a positive connection.
8. Coupling unit according to one of embodiments 5 to 7, wherein said connecting flanges (82, 84) with one of their side edges are facing the central section (64) of the cross member (22) with a contour (86, 88), which is positively bonded to said central section (64).
9. Coupling unit according to one of embodiments 5 to 8, wherein said slot (80) and the contours of said connecting flanges (82, 84) facing said central section (64) of said cross bar (22) form a continuous closed contour which is positively bonded to said cross member (22).
10. Coupling unit according to one of embodiments 5 to 9, wherein said connecting flanges (82, 84) extend in transverse direction to said longitudinal portions (66, 68) of said mounting element (62).
11. Coupling element according to embodiment 10, wherein said connecting flanges (82, 84) extend parallel to planes which run transverse to the planes in which said longitudinal portions (66, 68) extend.
12. Coupling unit according to one of embodiments 5 to 11, wherein said longitudinal portions (66, 68) and said connecting flanges (82, 84) are formed from one piece.
13. Coupling unit according to one of the preceding embodiments, wherein said positive bonding is achieved by at least one longitudinal bonding seam (130, 140).
14. Coupling unit according to embodiment 13, wherein said positive bonding is achieved by at least one longitudinal bonding seam (130, 140) extending on one of opposite side faces (76, 68) of said central section (64) of said cross member (22) arranged in said slot (80).
15. Coupling unit according to one of the preceding embodiments, wherein said positive bonding is achieved by at least one continuous bonding seam (130, 140) extending along the longitudinal portions (66, 68) and the respective side faces (76, 78) of said central section (64) of said cross member (22) for positively connecting said longitudinal portions (66, 68) to said side faces (76, 78).
16. Coupling unit according to one of the preceding embodiments, wherein said positive bonding is achieved by a continuous closed positive bonding seam (130, 140) connecting said longitudinal portions (66, 68) and said connecting flanges (82, 84) to said central section (64) of said cross member (22).
17. Coupling unit according to one of the preceding embodiments, wherein said positive bonding is achieved by a positive bonding seam (130) arranged on said mounting element (62) on a side opposite to said connecting flanges (82, 84).
18. Coupling unit according to one of the preceding embodiments, wherein said positive bonding is achieved by a positive bonding seam (140) arranged on a side of said mounting element (62) on which said connecting flanges (82, 84) are extending.
19. Coupling unit according to one of the preceding embodiments, wherein said positive bonding seam (130) is arranged on a side of said mounting element (62) opposite to a mounting flange (90) which is connected to said mounting element (62) and adapted for fixing said coupling element (40).
20. Coupling unit according to one of the preceding embodiments, wherein said positive bonding is achieved by a positive bonding seam (140) arranged on a side of said mounting element (62) directed towards a mounting flange (90) which is connected to said mounting element (62) and adapted for fixing the coupling element (40).
21. Coupling unit according to one of the preceding embodiments, wherein said mounting element (62) on its side directed towards a road surface (54) is carrying a mounting flange (90) extending transverse to the central section (64) of said cross member (22) and transverse to the longitudinal portions (66, 68) of the mounting element (62).
22. Coupling unit according to embodiment 21, wherein the mounting flange (90) is adapted to receive a bearing unit (30) to which the coupling element (40) is connected.
23. Coupling unit according to embodiment 22, wherein said bearing unit (30) is designed to enable swiveling the coupling element (40) between a working position, in which the coupling element (40) extends transverse to said cross member (22) and a rest position, in which the coupling element (40) extends transverse to a longitudinal vertical center plane (VVP) of the vehicle (10) and/or the coupling unit (20).
24. Coupling unit according to one of the preceding embodiments, wherein said mounting flange (90) is stabilized with respect to said mounting element (62) at least one stabilizer (112, 114) which is fixed to said mounting element (62) and to said mounting flange (90).
25. Coupling unit according to embodiment 24, wherein said mounting flange (90) extends between two stabilizers (112, 114) and is fixed to each of these stabilizers (112, 114).

Further advantageous features and solutions are disclosed in the following description and drawings of advantageous embodiments.

### BRIEF DESCRIPTION OF THE DRAWINGS

FIG. 1 shows a perspective and partly cut-away view of a motor vehicle having a coupling unit according to the invention;

FIG. 2 shows a perspective view of a first exemplary embodiment of the coupling unit according to the invention;

FIG. 3 shows a perspective view of a connecting element of the coupling unit in the direction of the arrow A in FIG. 2;

FIG. 4 shows a perspective view of the connecting element according to FIG. 3 in the direction of the arrow B in FIG. 2;

FIG. 5 shows a perspective view according to FIG. 2 with a positive bonding bead connecting a mounting element of the connecting element to a central section of a cross member of the coupling unit;

FIG. 6 shows a perspective view of the mounting element with the closed positive

bonding bead according to FIG. 5 without the central section of the cross member;

FIG. 7 shows a perspective view similar to FIG. 5 of a second embodiment, having the positive bonding bead on another side;

FIG. 8 shows a perspective view similar to FIG. 6 of the second embodiment;

### DETAILED DESCRIPTION OF THE INVENTION

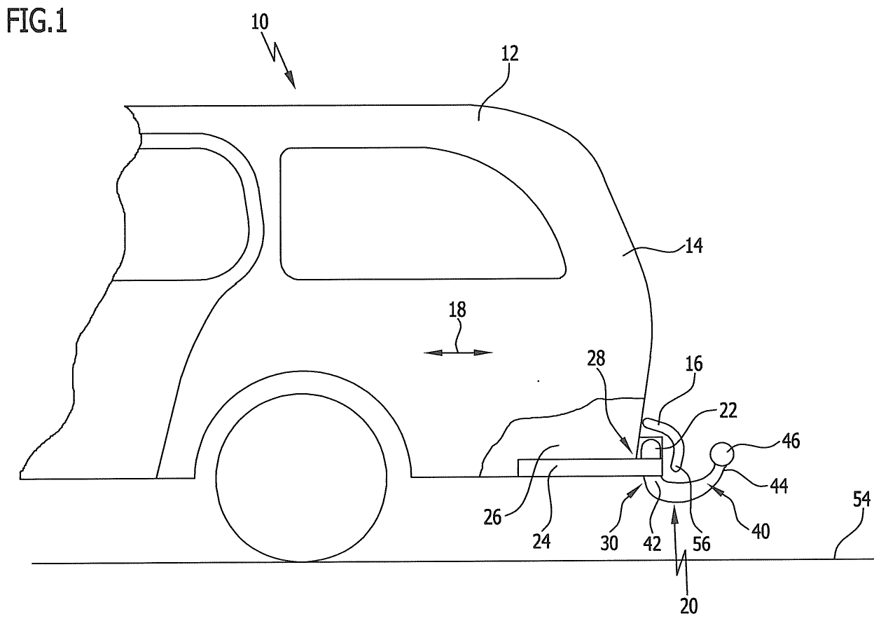

A motor vehicle that is designated 10 as a whole in FIG. 1 comprises a vehicle body 12, on which there is mounted in a rear region 14 a coupling unit 20 according to the invention that has a cross member 22, which is covered by a bumper unit 16 and extends transversely to a longitudinal direction 18 of the vehicle body 12 and transversely to a vertical vehicle longitudinal center plane VVP over the rear region 14, and supports 24, which for example extend approximately parallel to the longitudinal direction 18 of the motor vehicle 12 along body wall portions 26 and are fixed thereto or which abut on the rear region 14 for example by forming flanges and which, together with the cross member 22, form a carrier unit 28 that is covered partly by the vehicle body 12 and partly by the bumper unit 16.

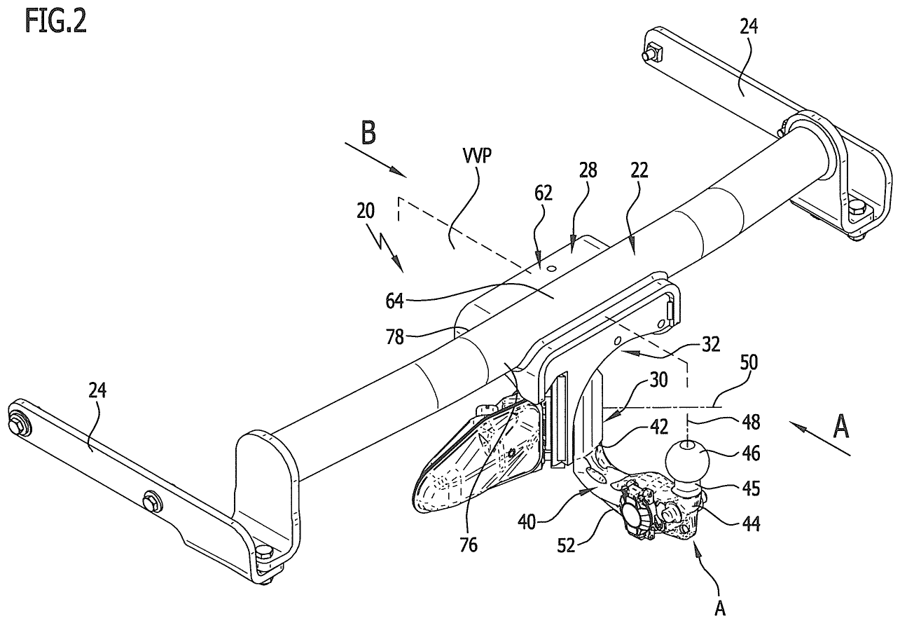

Provided on the carrier unit 28 is a connecting element 32 for a bearing unit that is designated 30 as a whole, for example a pivot bearing unit, to which a coupling element that is designated 40 as a whole, for example a ball neck, is connected by means of a first end 42 and extending therefrom to at a second end 44 at which for example a ball carrier 45 with a coupling ball 46, is connected as illustrated in FIGS. 1 and 2.

For example the pivot bearing unit 30 provides the possibility of pivoting the coupling element 40 from an operative position A, which is illustrated in FIG. 2 and in which a center axis 48 of the ball carrier 45 and the coupling ball 46 lies in a vertical vehicle longitudinal center plane VVP that runs parallel to the longitudinal direction 18, about a pivot axis 50 that runs transversely, in particular obliquely and preferably at an acute angle to the vertical vehicle longitudinal center plane VVP, into a rest position in which a central portion 52 of the coupling element extends transversely to the vehicle longitudinal center plane VVP and the coupling ball 46 is arranged laterally with respect to the vertical vehicle longitudinal center plane VVP.

In particular, in this arrangement the coupling element 40 in the rest position is arranged in a position that is covered by the bumper unit 16 of the vehicle body 12, and arranged laterally with respect to the vehicle longitudinal center plane VVP.

With such an arrangement of the pivot axis 50, in particular there is the possibility of arranging the coupling element 40 in the rest position on a side of the coupling ball 46 remote from or opposite to a road surface 54.

There is at least the possibility of arranging the coupling element 40 in the rest position at a spacing from the road surface 54 such that it is higher up than a lower edge 56 of the bumper unit 16, in relation to the course of the road surface 54.

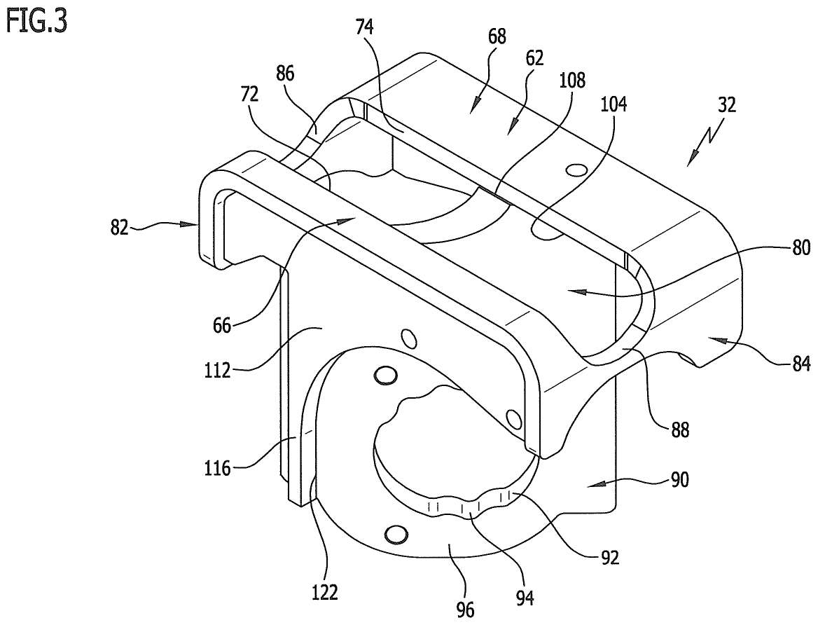

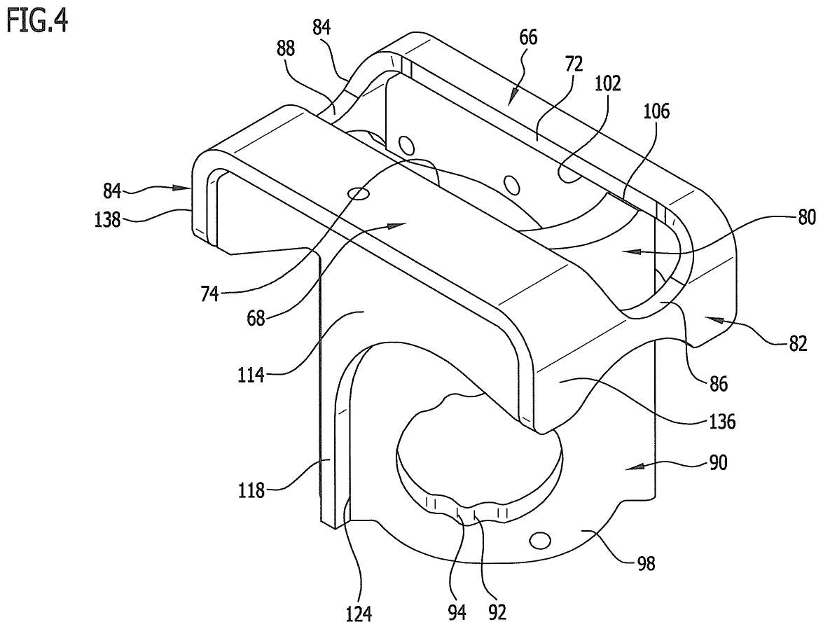

Connecting element 32, as shown in FIGS. 2 to 4, comprises a mounting element 62 provided for fixing said connecting element 32 to said cross member 22 in a central section 64 arranged in the middle thereof.

For this reason mounting element 62 is provided with two longitudinal portions 66, 68 extending on opposite sides of said central section 64 of the cross member 22 and forming with their longitudinal sides 72, 74, abutting on opposite side faces 76, 78 of said central section 64 said cross member 22 a slot 80 which receives said central section 64 of said cross member 22, so that the longitudinal sides 72, 74 can be connected to side faces 76, 78 of central section 64 by welding.

In addition longitudinal portions 66, 68 are connected with each other by connecting flanges 82, 84 which extend transverse to longitudinal portions 66, 68 and the connecting flanges 82, 84 are provided on one of their side edges with recesses 86, 88 which are adapted to the outer contour of central section 64 of cross member 22, so that the recesses 86, 88 can be also connected to central section 64 by welding.

In particular it is of advantage if longitudinal portions 66 and 68 as well as connecting flanges 82 and 84 connecting these longitudinal portions 66, 68 with each other are made of a flat material and that slot 80 with joining recesses 86, 88 is formed by a cutting process, in particular a laser cutting process, and that connecting flanges 82 and 84 for example after forming recesses 86, 88 are bent with respect to longitudinal portions 86, 88 in order to extend transverse, in particular at right angle, to longitudinal portions 66, 68 and thereafter mounting element 62 is connected to central section 64 of cross member 22 by welding.

Further connecting element 32 comprises in addition to mounting element 62 a mounting flange 90 for receiving and supporting bearing unit 30.

In particular mounting flange 90 comprises a central opening 92 through which bearing unit 30 can partially extent and in which bearing unit 30 can be fixed against rotation by a non-circular inner contour 94 of central opening 92 and further bearing unit 90 can be fixed by abutting on one or both flange surfaces 96 of mounting flange 90.

Mounting flange 90 is for example connected to mounting element 62 by abutting with its faces 106 and 108 extending between the two flange surfaces 96, 98 on lower sides 102 and 104 of longitudinal portions 66, 68, which are directed towards road surface 54.

In order to further stabilize mounting flange 90 with respect to mounting element 62 connecting element 32 is provided with stabilizers 112, 114 which are preferably made of flat material and are abutting on surfaces 102 and 104 of longitudinal portions 66 and 68 and also extending between connecting flanges 82, 84 in order to enable a stable support of stabilizers 112 and 114 with respect to mounting element 62 and further stabilizers 112 and 114 are provided with protusions 116, 118 extending in the same direction as mounting flange 90 and being connected to mounting flange 90 on opposite sides 122, 124 which extend transverse to longitudinal portions 66, 68.

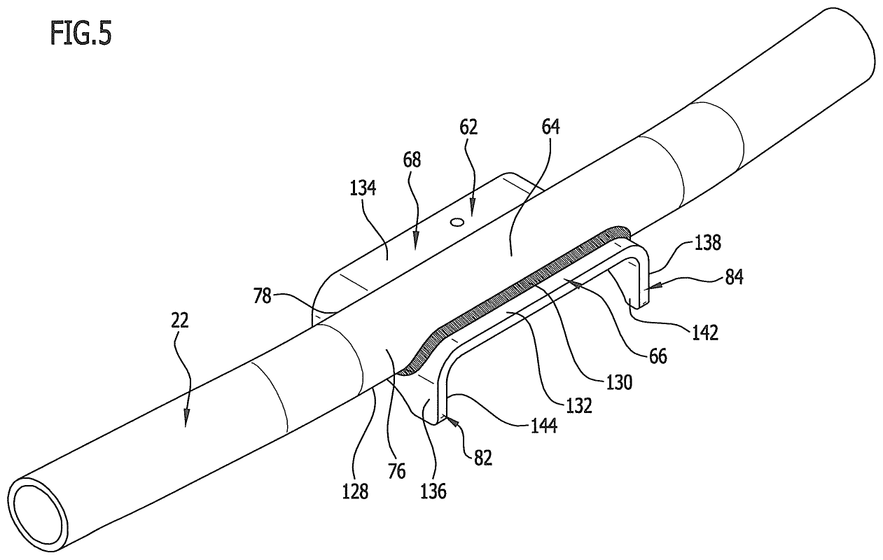

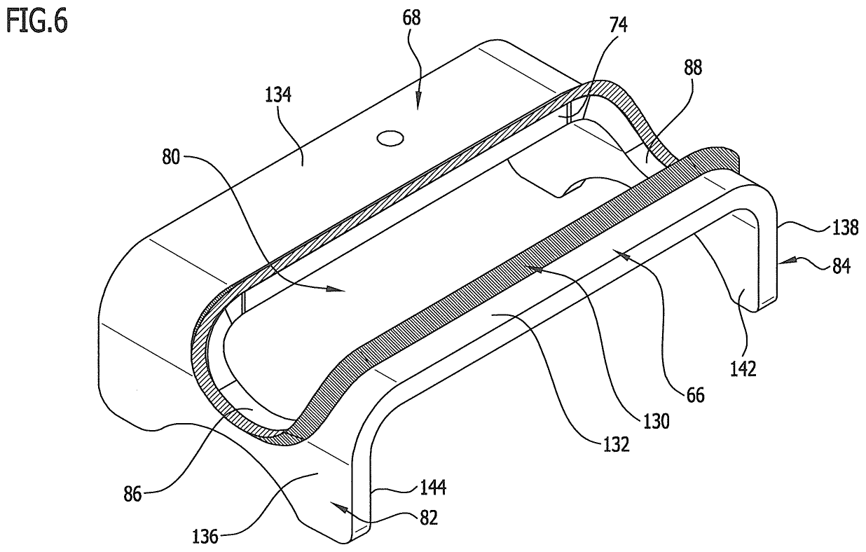

Mounting element 62 can be connected to central section 64 of cross member 22 by a welding bead 130 representing a positive bonding connection which as shown in FIGS. 5 and 6 extends along longitudinal sides 72, 74 as well as along recesses 86, 88 on a side opposite to said mounting flange 90 and therefore connects longitudinal sides 72, 74 as well as recesses 86, 88 to the circumference of central section 64 of cross member 22 on side faces 76, 78 as well as on lower face 128 of central section 64.

As shown in FIGS. 5 and 6 welding bead 130 connects upper sides 132, 134 arranged on longitudinal portions 66, 68 opposite to road surface 54 along longitudinal sides 72 and 74 as well as outer surfaces 136, 138 of connecting flanges 82, 84 along recesses 86, 88 to side faces 76, 78 as well as lower face 128 of central portion 64.

It is of advantage that, as shown in FIG. 6, welding bead 130 is formed as a closed welding bead so that mounting element 62 on one hand is tightly connected to central section 64 of cross member 22 and also stiffens cross member 22 within its central section 64 and in addition welding bead 130 forms a stable long-life connection between mounting element 62 and central section 64 due to the fact that it is insensitive to stress and therefore prevents interruptions.

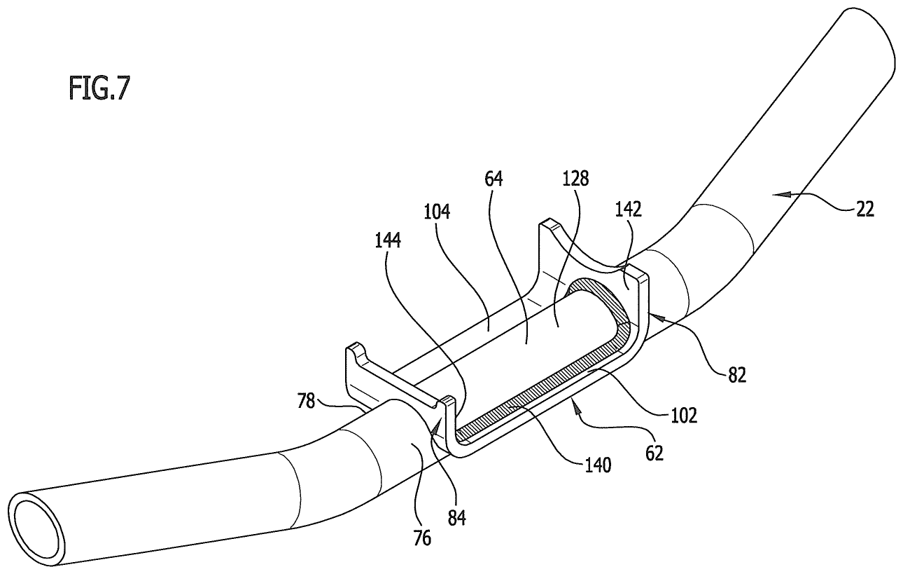

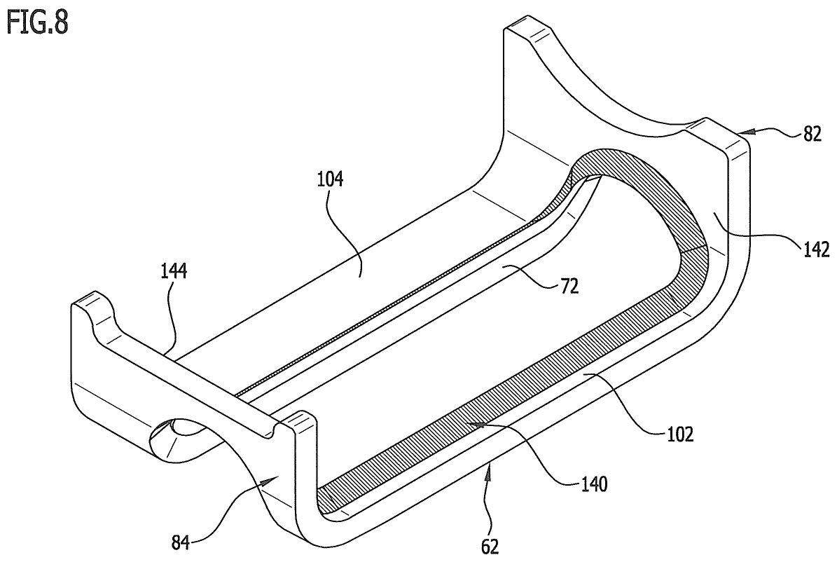

FIGS. 7 and 8 show another possibility for connecting mounting element 62 to central section 64 by arranging a closed welding bead 140 on a side of mounting element 62 connecting surfaces 102 and 104 to side surfaces 76 and 78 of central section 64 as well as inner surfaces 142, 144 of connecting flanges 82 an 84 to lower face 128.

In the same way as explained in connection with FIGS. 5 and 6 and welding bead 130 welding bead 140 representing a positive bonding connection is also a continuous closed welding bead connecting lower surfaces 102 and 104 of central section 64 to side faces 76, 78 of central section 64 as well as inner sides 146 and 148 of connecting flanges 82, 84 to lower face 128 of central section 64.

1. A coupling unit for vehicles comprising a cross member mounted on a rear region of a vehicle body, a connecting element fixed to said cross member and being adapted to carry a coupling element for coupling a trailer or load carrier to said vehicle, wherein said connecting element comprises a mounting element provided with a slot for receiving a central section of said cross member, and that said slot forms a contour for being positively bonded to said central section of the cross member on opposite longitudinal side faces of the central section.

2. The coupling unit according to claim 1, wherein said mounting element comprises two longitudinal portions forming said slot by being arranged on opposite sides thereof.

3. The coupling unit according to claim 1, wherein said slot extends along said central section of said cross member.

4. The coupling unit according to claim 2, wherein said two longitudinal portions extend along said central section of said cross member over a distance corresponding to at least two times, preferably at least three times, the width of said slot.

5. The coupling unit according to claim 1, wherein said mounting element is provided with connecting flanges connecting said two longitudinal portions of said mounting element.

6. The coupling unit according to claim 5, wherein said connecting flanges are arranged at the respective ends of said longitudinal portions.

7. The coupling unit according to claim 5, wherein said connecting flanges are connected to said central section of said cross member by a positive connection.

8. The coupling unit according to claim 5, wherein said connecting flanges with one of their side edges are facing the central section of the cross member with a contour, which is positively bonded to said central section.

9. The coupling unit according to claim 5, wherein said slot and the contours of said connecting flanges facing said central section of said cross bar form a continuous closed contour which is positively bonded to said cross member.

10. The coupling unit according to claim 5, wherein said connecting flanges extend in transverse direction to said longitudinal portions of said mounting element.

11. The coupling element according to claim 10, wherein said connecting flanges extend parallel to planes which run transverse to the planes in which said longitudinal portions extend.

12. The coupling unit according to claim 5, wherein said longitudinal portions and said connecting flanges are formed from one piece.

13. The coupling unit according to claim 1, wherein said positive bonding is achieved by at least one longitudinal bonding seam.

14. The coupling unit according to claim 13, wherein said positive bonding is achieved by at least one longitudinal bonding seam extending on one of opposite side faces of said central section of said cross member arranged in said slot.

15. The coupling unit according to claim 1, wherein said positive bonding is achieved by at least one continuous bonding seam extending along the longitudinal portions and the respective side faces of said central section of said cross member for positively connecting said longitudinal portions to said side faces.

16. The coupling unit according to claim 1, wherein said positive bonding is achieved by a continuous closed positive bonding seam connecting said longitudinal portions and said connecting flanges to said central section of said cross member.

17. The coupling unit according to claim 1, wherein said positive bonding is achieved by a positive bonding seam arranged on said mounting element on a side opposite to said connecting flanges.

18. The coupling unit according to claim 1, wherein said positive bonding is achieved by a positive bonding seam arranged on a side of said mounting element on which said connecting flanges are extending.

19. The coupling unit according to claim 1, wherein said positive bonding seam is arranged on a side of said mounting element opposite to a mounting flange which is connected to said mounting element and adapted for fixing said coupling element.

20. The coupling unit according to claim 1, wherein said positive bonding is achieved by a positive bonding seam arranged on a side of said mounting element directed towards a mounting flange which is connected to said mounting element and adapted for fixing the coupling element.

21. The coupling unit according to claim 1, wherein said mounting element on its side directed towards a road surface is carrying a mounting flange extending transverse to the central section of said cross member and transverse to the longitudinal portions of the mounting element.

22. The coupling unit according to claim 21, wherein the mounting flange is adapted to receive a bearing unit to which the coupling element is connected.

23. The coupling unit according to claim 22, wherein said bearing unit is designed to enable swiveling the coupling element between a working position, in which the coupling element extends transverse to said cross member and a rest position, in which the coupling element extends transverse to a longitudinal vertical center plane of at least one of (i) the vehicle and (ii) the coupling unit.

24. The coupling unit according to claim 1, wherein said mounting flange is stabilized with respect to said mounting element at least one stabilizer which is fixed to said mounting element and to said mounting flange.

25. The coupling unit according to claim 24, wherein said mounting flange extends between two stabilizers and is fixed to each of these stabilizers.
